(19) United States
(12) Patent Application Publication
(10) Pub. No.: US 2025/0066608 A1
(43) Pub. Date: Feb. 27, 2025

(54) SINTER POWDER (SP) COMPRISING AT LEAST ONE POLYAMIDE MXD6 AND AT LEAST ONE SEMICRYSTALLINE POLYAMIDE

(71) Applicant: BASF SE, Ludwigshafen am Rhein (DE)

(72) Inventors: Claus GABRIEL, Ludwigshafen am Rhein (DE); Clemens GOTTKE, Ludwigshafen am Rhein (DE)

(21) Appl. No.: 18/727,746

(22) PCT Filed: Jan. 10, 2023
(86) PCT No.: PCT/EP2023/050484

§ 371 Date: Jul. 10, 2024

(30) Foreign Application Priority Data
Jan. 11, 2022 (EP) 22150975.5

(51) Int. Cl. C08L 77/02; B29C 64/153; B29K 77/00; B29K 105/06; B33Y 70/00; C08K 3/013; C08K 11/00

(52) U.S. Cl. CPC C08L 77/02; B29C 64/153; B33Y 70/00; C08K 3/013; C08K 11/00; B29K 2077/10; B29K 2105/06; C08L 2666/72

(57) ABSTRACT

The present invention relates to a sinter powder (SP) comprising at least one polyamide MXD6 (A), at least one semicrystalline polyamide (B), optionally at least one additive (C) and optionally at least one reinforcer (D). The present invention further relates to a method of producing a shaped body using the inventive sinter powder (SP), to a shaped body obtained by this method and to the use of the inventive sinter powder (SP) in a sintering method. In addition, the present invention relates to a method of producing the sinter powder (SP) and to the use of at least one semicrystalline polyamide (B) in a sinter powder (SP) comprising at least one polyamide MXD6 (A) for improving the mechanical properties of shaped bodies made from said sinter powder (SP).

The present invention relates to a sinter powder (SP) comprising at least one polyamide MXD6 (A), at least one semicrystalline polyamide (B), optionally at least one additive (C) and optionally at least one reinforcer (D). The present invention further relates to a method of producing a shaped body using the inventive sinter powder (SP), to a shaped body obtained by this method and to the use of the inventive sinter powder (SP) in a sintering method. In addition, the present invention relates to a method of producing the sinter powder (SP) and to the use of at least one semicrystalline polyamide (B) in a sinter powder (SP) comprising at least one polyamide MXD6 (A) for improving the mechanical properties of shaped bodies made from said sinter powder (SP).

The rapid provision of prototypes is a problem often addressed in very recent times. One process, which is particularly suitable for this so-called “rapid prototyping”, is selective laser sintering (SLS). This involves selectively exposing of a polymer powder in a chamber with a laser beam. The powder melts; the molten particles coalesce and resolidify. Repeated application of polymer powder and subsequent exposure to a laser allows modelling of three-dimensional shaped bodies.

The process of selective laser sintering for producing shaped bodies from pulverulent polymers is described in detail in patent specifications U.S. Pat. No. 6,136,948 and WO 96/06881.

Selective laser sintering is frequently too time-consuming for the production of a relatively large number of shaped bodies, and so it is possible to produce relatively large volumes of shaped bodies using high-speed sintering (HSS) or “multi-jet fusion technology” (MJF) from HP. In high-speed sintering, by spray application of an infrared-absorbing ink onto the component cross section to be sintered, followed by exposure with an infrared source, a higher processing speed is achieved compared to selective laser sintering.

Polymers often used as polymer powders in selective laser sintering are polyamide 6, polyamide 12 and polyamide 66. However, for example, polyamide MXD6 shows advantages over polyamide 6, polyamide 12 and polyamide 66 such as higher strength and stiffness, a high glass transition temperature and thus more temperature-independent mechanical properties, low water absorption and permeability, and generally excellent barrier properties against oxygen and CO₂.

Nevertheless, polyamide MXD6 has not yet been used for three-dimensional printing processes using powder bed-based techniques such as SLS, as it has a high melting temperature and, therefore, requires high build temperatures. Furthermore, the crystallization of polyamide MXD6 is rather inconsistent (broad crystallization peak) and the crystallization temperature is increased because of the sinter powder production via cryo-grinding compared to the granulate or an injection moulded component. This is particularly disadvantageous in powder sintering, as it leads to a reduction in the sintering window and thus to distortion of components. In addition, polyamide MXD6 is already brittle as an injection moulding material. Since SLS components of stiff, semi-crystalline polymers are generally always much more brittle than those from injection moulding, polyamide MXD6 cannot be used directly for SLS.

In the previous state of the art, mixtures of polyamide MXD6 with other components are described in order to improve the processability of polyamide MXD6, especially as injection moulding material or in films.

In the article “Miscibility in Binary Blends of Aromatic and Alicyclic Polyamides” by M. Endo et al. (Journal of Applied Polymer Science, 101, 3971-3978, 2006), blends of polyamide MXD6 and polyamide 61/6T are described.

In the article “The linear tearing properties of biaxially oriented PA6/MXD6 blending films” by F. Lin et al. (Journal of Applied Polymer Science, 2020, 137: e49108), polyamide MXD6 is added as a second component to polyamide 6 to improve the barrier performance in polyamide 6 films.

In the article “Dynamics and structure development for biaxial stretching PA6/MXD6 blend packaging films” by T. Kanai et al. (Advances in Polymer Technology, 37, 2828-2837, 2018), also blends of polyamide MXD6 and polyamide 6 are investigated for biaxially stretched films.

It is thus an object of the present invention to provide an improved sinter powder (SP) comprising polyamide MXD6 which, in a process for the production of shaped bodies by laser sintering, does not have, or only has to a small extent, the aforementioned disadvantages of the sinter powders and processes described in the prior art. The sinter powder and the process should be as simple and inexpensive as possible to produce and carry out.

This object is achieved by a sinter powder (SP) comprising the following components:
(A) at least one polyamide MXD6,
(B) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
(C) optionally at least one additive and
(D) optionally at least one reinforcer.

It has been found that, surprisingly, the sinter powder (SP) of the invention can be used efficiently in selective laser sintering methods, high-speed sintering methods and multi-jet fusion methods.

The shaped bodies obtained by these methods show improved mechanical properties compared to shaped bodies comprising pure polyamide MXD6, for example, an improved elongation at break and elongation at yield.

By using the inventive sinter powder (SP) in selective laser sintering methods, surprisingly, the crystallisation of the sinter powder (SP) is more consistent and the crystallisation temperature is significantly lowered compared to a sinter powder comprising pure polyamide PA MXD6.

The sinter powder (SP) of the invention is elucidated in detail hereinafter.

### Sinter Powder (SP)

According to the invention, the sinter powder (SP) comprises at least one polyamide MXD6 as component (A), at least one semicrystalline polyamide as component (B), optionally at least one additive as component (C), and optionally at least one reinforcer as component (D).

In the context of the present invention, the terms “component (A)” and “at least one polyamide MXD6” are used synonymously and therefore have the same meaning. The same applies to the terms “component (B)” and “at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6”. These terms are likewise used synonymously in the context of the present invention and therefore have the same meaning.

Accordingly, the terms “component (C)” and “at least one additive”, and “component (D)” and “at least one reinforcer” are also each used synonymously in the context of the present invention and therefore have the same meaning.

In a preferred embodiment, the sinter powder (SP) comprises in the range from 50% to 95% by weight of component (A), in the range from 5% to 50% by weight of component (B), in the range from 0% to 20% by weight of component (C), and in the range from 0% to 40% by weight of component (D), based in each case on the total weight of the sinter powder (SP).

The percentages by weight of components (A), (B), and optionally of components (C) and (D), typically add up to 100% by weight.

The present invention thus also provides a sinter powder (SP) comprising in the range from 50% to 95% by weight of component (A), in the range from 5% to 50% by weight of component (B), in the range from 0% to 20% by weight of component (C), and in the range from 0% to 40% by weight of component (D), based in each case on the total weight of the sinter powder (SP).

The sinter powder (SP) comprises particles. These particles have, for example, a median particle size (D50) in the range from 40 to 80 μm, preferably in the range from 45 to 75 μm, and more preferably in the range from 50 to 75 μm.

The sinter powder (SP) of the invention has, for example,
a D10 in the range from 10 to 60 μm,
a D50 in the range from 40 to 80 μm and
a D90 in the range from 50 to 150 μm.

Preferably, the sinter powder (SP) of the invention has
a D10 in the range from 20 to 50 μm,
a D50 in the range from 45 to 75 μm and
a D90 in the range from 80 to 125 μm.

The present invention therefore also provides a sinter powder (SP) having
a D10 in the range from 10 to 60 μm,
a D50 in the range from 40 to 80 μm and
a D90 in the range from 50 to 150 μm.

The present invention therefore also provides a sinter powder (SP) having a median particle size (D50) in the range from 40 to 80 μm.

In the context of the present invention, the “D10” is understood to mean the particle size at which 10% by volume of the particles based on the total volume of the particles are smaller than or equal to D10 and 90% by volume of the particles based on the total volume of the particles are larger than D10. By analogy, the “D50” is understood to mean the particle size at which 50% by volume of the particles based on the total volume of the particles are smaller than or equal to D50 and 50% by volume of the particles based on the total volume of the particles are larger than D50. Correspondingly, the “D90” is understood to mean the particle size at which 90% by volume of the particles based on the total volume of the particles are smaller than or equal to D90 and 10% by volume of the particles based on the total volume of the particles are larger than D90.

To determine the particle sizes, the sinter powder (SP) is suspended in a dry state using compressed air or in a solvent, for example water or ethanol, preferably suspended in a dry state using compressed air, and this suspension is analyzed. The D10, D50 and D90 values are determined by laser diffraction using a Malvern Mastersizer 3000. Evaluation is by means of Fraunhofer diffraction.

The sinter powder (SP) typically has a melting temperature (T_{M(SP)}) in the range from 190 to 250° C. Preferably, the melting temperature (T_{M(SP)}) of the sinter powder (SP) is in the range from 210 to 240° C.

The melting temperature (T_{M(SP)}) is determined in the context of the present invention by means of differential scanning calorimetry (DSC). Typically, a heating run (H1) and a cooling run (C) are measured, each at a heating rate/cooling rate of 20 K/min. This affords a DSC diagram. The melting temperature (T_{M(SP)}) is then understood to mean the temperature at which the melting peak of the heating run (H1) of the DSC diagram has a maximum.

The present invention therefore also provides a sinter powder (SP), wherein the melting temperature (T_{M(SP)}) of the sinter powder (SP) is in the range from 190 to 250° C.

The sinter powder (SP) typically also has a crystallization temperature (T_{C(SP)}) in the range from 140 to 200° C. Preferably, the crystallization temperature (T_{C(SP)}) of the sinter powder (SP) is in the range from 150 to 190° C. and especially preferably in the range from 160 to 180° C.

The crystallization temperature (T_{C}) is determined in the context of the present invention by means of differential scanning calorimetry (DSC). As described above, this customarily involves measuring a heating run (H) and a cooling run (C). This gives a DSC diagram. The crystallization temperature (T_{C}) is then the temperature at the minimum of the crystallization peak of the DSC curve.

The present invention therefore also provides a sinter powder (SP), wherein the crystallization temperature (T_{C(SP)}) of the sinter powder (SP) is in the range from 140 to 200° C.

The sinter powder (SP) typically also has a glass transition temperature (T_{G(SP)}). The glass transition temperature (T_{G(SP)}) of the sinter powder (SP) is, for example, in the range from 60 to 100° C., and preferably in the range from 70 to 90° C.

The glass transition temperature (T_{G(SP)}) of the sinter powder (SP) is determined by means of differential scanning calorimetry. For determination, in accordance with the invention, first a first heating run (H1), then a cooling run (C) and subsequently a second heating run (H2) is measured on a sample of the sinter powder (SP). The heating rate in the first heating run (H1) and in the second heating run (H2) is 20 K/min; the cooling rate in the cooling run (C) is likewise 20 K/min. In the region of the glass transition of the sinter powder (SP), a step is obtained in the second heating run (H2) in the DSC diagram. The glass transition temperature (T_{G(SP)}) of the sinter powder (SP) corresponds to the temperature at half the step height in the DSC diagram. This process for determination of the glass transition temperature is known to those skilled in the art.

The sinter powder (SP) can be produced by any methods known to those skilled in the art. For example, the sinter powder (SP) is produced by grinding, by precipitation, by melt emulsification, by spray extrusion or by microgranulation. The production of the sinter powder (SP) by grinding, by precipitation, by melt emulsification, by spray extrusion or by microgranulation is also referred to as micronization in the context of the present invention.

If the sinter powder (SP) is produced by precipitation, components (A) and (B), and optionally (C) and (D), are usually mixed with a solvent, and component (A) and component (B) are dissolved in the solvent, optionally with heating, to obtain a solution. The precipitation of the sinter powder (SP) is then carried out, for example, by cooling the solution, distilling off the solvent from the solution or adding a precipitating agent to the solution.

Grinding can be carried out by any method known to a person skilled in the art, for example, components (A) and (B), and optionally (C) and (D), are introduced in a mill and ground therein.

Suitable mills include all mills known to those skilled in the art, for example classifier mills, opposed jet mills, hammer mills, ball mills, vibratory mills or rotor mills such as pinned disk mills and whirlwind mills.

The grinding in the mill can likewise be effected by any methods known to those skilled in the art. For example, the grinding can take place under inert gas and/or while cooling with liquid nitrogen. Cooling with liquid nitrogen is preferred. The temperature in the grinding is as desired; the grinding is preferably performed at liquid nitrogen temperatures, for example at a temperature in the range from-210 to ˜195° C. The temperature of the components on grinding in that case is, for example, in the range from −40 to ˜10° C.

Preferably, the components are first mixed with one another and then ground.

Preferably, at least components (A) and (B) are in the form of granules before micronization. In addition to components (A) and (B), components (C) and (D) may also be present in the form of granules. The granulate can be spherical, cylindrical or elliptical, for example. In the context of the present invention, in a preferred embodiment, a granulate is used which comprises components (A) and (B), and optionally (C) and (D), premixed.

The method of producing the sinter powder (SP) then preferably comprises the steps of
a) mixing components (A) and (B), and optionally (C) and/or (D):
   (A) at least one polyamide MXD6,
   (B) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
   (C) optionally at least one additive, and/or
   (D) optionally at least one reinforcer,
   in an extruder to obtain an extrudate (E) comprising components (A) and (B), and optionally (C) and/or (D),
b) pelletizing the extrudate (E) obtained in step a) to obtain a granulate (G) comprising components (A) and (B), and optionally (C) and/or (D),
c) micronizing the granulate (G) obtained in step b) to obtain the sinter powder (SP), preferably by grinding.

It is therefore also an object of the present invention to provide a method of producing the sinter powder (SP) comprising the steps of
a) mixing components (A) and (B), and optionally (C) and/or (D):
   (A) at least one polyamide MXD6,
   (B) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
   (C) optionally at least one additive, and/or
   (D) optionally at least one reinforcer,
   in an extruder to obtain an extrudate (E) comprising components (A) and (B), and optionally (C) and/or (D),
b) pelletizing the extrudate (E) obtained in step a) to obtain a granulate (G) comprising components (A) and (B), and optionally (C) and/or (D),
c) micronizing the granulate (G) obtained in step b) to obtain the sinter powder (SP).

In a further preferred embodiment, the method of producing the sinter powder (SP) comprises the following steps:
a) mixing components (A) and (B), and optionally (C) and/or (D):
   (A) at least one polyamide MXD6,
   (B) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
   (C) optionally at least one additive, and/or
   (D) optionally at least one reinforcer,
   in an extruder to obtain an extrudate (E) comprising components (A) and (B), and optionally (C) and/or (D),
b) pelletizing the extrudate (E) obtained in step a) to obtain a granulate (G) comprising components (A) and (B), and optionally (C) and/or (D),
c1) micronizing the granulate (G) obtained in step b) to obtain a polyamide powder (PP),
c2) mixing the polyamide powder (PP) obtained in step c1) with a free-flow aid to obtain the sinter powder (SP).

If the sinter powder (SP) comprises component (D), a granulate is preferably used which comprises only components (A) and (B), and, optionally, component (C) premixed. The at least one reinforcing agent (D) is then preferably added after the micronization step.

The method of producing the sinter powder (SP) then preferably comprises the steps of
a) mixing components (A) and (B), and optionally (C):
   (A) at least one polyamide MXD6,
   (B) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6, and
   (C) optionally at least one additive,
   in an extruder to obtain an extrudate (E1) comprising components (A) and (B), and optionally (C),
b) pelletizing the extrudate (E1) obtained in step a) to obtain a granulate (G1) comprising components (A) and (B), and optionally (C),
c) micronizing the granulate (G1) obtained in step b) to obtain a sinter powder (SP1), preferably by grinding,
d) mixing the sinter powder (SP1) and component (D):
   (D) at least one reinforcer,
   to obtain the sinter powder (SP).

If a free-flow aid is added during the process of producing the sinter powder (SP), the process then preferably comprises the following steps:
a) mixing components (A) and (B), and optionally (C):
   (A) at least one polyamide MXD6,
   (B) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6, and
   (C) optionally at least one additive,
   in an extruder to obtain an extrudate (E1) comprising components (A) and (B), and optionally (C),
b) pelletizing the extrudate (E1) obtained in step a) to obtain a granulate (G1) comprising components (A) and (B), and optionally (C),
c1) micronizing the granulate (G1) obtained in step b) to obtain a polyamide powder (PP1), preferably by grinding,
c2) mixing the polyamide powder (PP1) obtained in step c1) with a free-flow aid to obtain a sinter powder (SP2),
d) mixing the sinter powder (SP2) and component (D):
   (D) at least one reinforcer,
   to obtain the sinter powder (SP).

Suitable free-flow aids are, for example, silicas, amorphous silicon oxide or aluminium oxides. A suitable aluminium oxide is, for example, Aeroxide® Alu C from Evonik. A suitable amorphous silica is, for example, HDK N20 from Wacker.

Thus, it is also an object of the present invention to provide a sinter powder (SP) in which the free-flow aid in step c2) is selected from silicas, amorphous silicon oxide and/or aluminium oxides.

In the case that the sinter powder (SP) comprises a free-flow aid, this is preferably added in process step c2). In one preferred embodiment, the sinter powder (SP) comprises 0.02 to 1% by weight, preferably 0.05 to 0.8% by weight and particularly preferably 0.1 to 0.6% by weight of the free-flow aid, in each case based on the total weight of the polyamide powder (PP) or (PP1), respectively, and the free-flow aid.

For the grinding in step c) and in step c1), the previously described explanations and preferences with regard to the grinding apply accordingly.

A further object of the present invention is therefore also the sinter powder (SP), obtained by the process according to the invention.

### Component (A)

According to the invention, component (A) is at least one polyamide MXD6. In the context of the present invention, the terms “component (A)” and “at least one polyamide MXD6” are used synonymously and therefore have the same meaning. In the context of the present invention, “at least one polyamide MXD6” means either exactly one polyamide MXD6 or mixtures of two or more polyamides MXD6. Preferably, component (A) is exactly one polyamide MXD6.

Preferably, component (A) consists of units derived from m-xylylenediamine and from adipic acid.

In other words, component (A) is thus a polymer prepared from m-xylylenediamine and from adipic acid.

Component (A) has a melting temperature (T_{M(A)}). The melting temperature (T_{M(A)}) of component (A) is typically in the range from 200 to 260° C., preferably in the range from 210 to 250° C. and especially preferably in the range from 220 to 240° C. The melting temperature (T_{M(A)}) of component (A) is determined by means of differential scanning calorimetry as described above for the determination of the melting temperature (T_{M(SP)}) of the sinter powder (SP).

Component (A) has a glass transition temperature (T_{G(A)}). The glass transition temperature (T_{G(A)}) of component (A) is typically in the range from 70 to 110° C., preferably in the range from 75 to 105° C. and especially preferably in the range from 80 to 100° C. The glass transition temperature (T_{G(A)}) of component (A) is determined by means of differential scanning calorimetry as described above for the determination of the glass transition temperature (T_{G(SP)}) of the sinter powder (SP).

The zero shear rate viscosity η₀ of component (A) is, for example, in the range from 770 to 3250 Pas. The zero shear rate viscosity η₀ is determined with a “DHR-1” rotary viscometer from TA Instruments and a plate-plate geometry with a diameter of 25 mm and a plate separation of 1 mm. Unequilibrated samples of component (A) are dried at 80° C. under reduced pressure for 7 days and these are then analyzed with a time-dependent frequency sweep (sequence test) with an angular frequency range of 500 to 0.5 rad/s. The following further analysis parameters were used: deformation: 1.0%, analysis temperature: 255° C., analysis time: 20 min, preheating time after sample preparation: 1.5 min.

Component (A) has an amino end group concentration (AEG) which is preferably in the range from 5 to 25 mmol/kg and especially preferably in the range from 10 to 20 mmol/kg.

For determination of the amino end group concentration (AEG), 1 g of component (A) is dissolved in 30 mL of a phenol/methanol mixture (volume ratio of phenol:methanol 75:25) and then subjected to potentiometric titration with 0.2 N hydrochloric acid in water.

Component (A) has a carboxyl end group concentration (CEG) which is preferably in the range from 40 to 100 mmol/kg and especially preferably in the range from 50 to 90 mmol/kg.

For determination of the carboxylic end group concentration (CEG), 1 g of component (A) is dissolved in 30 mL of benzyl alcohol. This is followed by visual titration at 120° C. with 0.05 N potassium hydroxide solution in water.

### Component (B)

According to the invention, component (B) is at least one semicrystalline polyamide. In the context of the present invention, the terms “component (B)” and “at least one semicrystalline polyamide” are used synonymously and therefore have the same meaning. In the context of the present invention, “at least one semicrystalline polyamide” means either exactly one semicrystalline polyamide or mixtures of two or more semicrystalline polyamides. Preferably, component (B) is exactly one semicrystalline polyamide.

“Semicrystalline” in the context of the present invention means that the polyamide has an enthalpy of fusion ΔH_{2(B)} of greater than 45 J/g, preferably of greater than 50 J/g and especially preferably of greater than 55 J/g, in each case measured by means of differential scanning calorimetry (DSC) according to ISO 11357-4:2014.

Component (B) of the invention also preferably has an enthalpy of fusion ΔH_{2(B)} of less than 200 J/g, more preferably of less than 150 J/g and especially preferably of less than 100 J/g, in each case measured by means of differential scanning calorimetry (DSC) according to ISO 11357-4:2014.

According to the invention, component (B) comprises at least one unit selected from the group consisting of —NH—(CH₂)ₘ—NH— units where m is 4, 5, 6, 7 or 8, —CO—(CH₂)ₙ—NH— units where n is 3, 4, 5, 6 or 7 and —CO—(CH₂)ₒ—CO— units where o is 2, 3, 4, 5 or 6.

Preferably, component (B) comprises at least one unit selected from the group consisting of —NH—(CH₂)ₘ—NH— units where m is 5, 6 or 7, —CO—(CH₂)ₙ—NH— units where n is 4, 5 or 6 and —CO—(CH₂)ₒ—CO— units where o is 3, 4 or 5.

Especially preferably, component (B) comprises at least one unit selected from the group consisting of —NH—(CH₂)₆—NH— units, —CO—(CH₂)₅—NH— units and —CO—(CH₂)₄—CO— units.

If component (B) comprises at least one unit selected from the group consisting of —CO—(CH₂)ₙ—NH— units, these units derive from lactams having 5 to 9 ring members, preferably from lactams having 6 to 8 ring members, especially preferably from lactams having 7 ring members.

Lactams are known to those skilled in the art. Lactams are generally understood in accordance with the invention to mean cyclic amides. According to the invention, these have 4 to 8 carbon atoms in the ring, preferably 5 to 7 carbon atoms and especially preferably 6 carbon atoms.

For example, the lactams are selected from the group consisting of butyro-4-lactam (γ-lactam, γ-butyrolactam), 2-piperidinone (δ-lactam; δ-valerolactam), hexano-6-lactam (ε-lactam; ε-caprolactam), heptano-7-lactam (ζ-lactam; ζ-heptanolactam) and octano-8-lactam (η-lactam; η-octanolactam).

Preferably, the lactams are selected from the group consisting of 2-piperidinone (δ-lactam; δ-valerolactam), hexano-6-lactam (ε-lactam; ε-caprolactam) and heptano-7-lactam (ζ-lactam; ζ-heptanolactam). Especially preferred is ε-caprolactam.

If component (B) comprises at least one unit selected from the group consisting of —NH—(CH₂)ₘ—NH— units, these units derive from diamines. In that case, component (B) is thus obtained by reaction of diamines, preferably by reaction of diamines with dicarboxylic acids.

Suitable diamines comprise 4 to 8 carbon atoms, preferably 5 to 7 carbon atoms and especially preferably 6 carbon atoms.

Diamines of this kind are selected, for example, from the group consisting of 1,4-diaminobutane (butane-1,4-diamine; tetramethylenediamine; putrescine), 1,5-diaminopentane (pentamethylenediamine; pentane-1,5-diamine; cadaverine), 1,6-diaminohexane (hexamethylenediamine; hexane-1,6-diamine), 1,7-diaminoheptane and 1,8-diaminooctane. Preference is given to the diamines selected from the group consisting of 1,5-diaminopentane, 1,6-diaminohexane and 1,7-diaminoheptane. 1,6-diaminohexane is especially preferred.

If component (B) comprises at least one unit selected from the group consisting of —CO—(CH₂)ₒ—CO— units, these units are typically derived from dicarboxylic acids. In that case, component (B) was thus obtained by reaction of dicarboxylic acids, preferably by reaction of dicarboxylic acids with diamines.

In that case, the dicarboxylic acids comprise 4 to 8 carbon atoms, preferably 5 to 7 carbon atoms and especially preferably 6 carbon atoms.

These dicarboxylic acids are, for example, selected from the group consisting of butanedioic acid (succinic acid), pentanedioic acid (glutaric acid), hexanedioic acid (adipic acid), heptanedioic acid (pimelic acid) and octanedioic acid (suberic acid). Preferably, the dicarboxylic acids are selected from the group consisting of pentanedioic acid, hexanedioic acid and heptanedioic acid; hexanedioic acid is especially preferred.

Component (B) may additionally comprise further units. For example units which derive from lactams having 10 to 13 ring members, such as caprylolactam and/or laurolactam.

In addition, component (B) may comprise units derived from dicarboxylic acid alkanes (aliphatic dicarboxylic acids) having 9 to 36 carbon atoms, preferably 9 to 12 carbon atoms, and more preferably 9 to 10 carbon atoms. Aromatic dicarboxylic acids are also suitable.

Examples of dicarboxylic acids include azelaic acid, sebacic acid, dodecanedioic acid and also terephthalic acid and/or isophthalic acid.

It is also possible for component (B) to comprise units, for example, derived from m-xylylenediamine, di(4-aminophenyl) methane, di(4-aminocyclohexyl) methane, 2,2-di(4-aminophenyl)propane and 2,2-di(4-aminocyclohexyl)propane and/or 1,5-diamino-2-methylpentane.

The following no exhaustive list comprises the preferred components (B) for use in the sinter powder (SP) of the invention and the monomers present:

AB polymers:

| | |
|---|---|
| PA 4 | pyrrolidone |
| PA 6 | ε-caprolactam |
| PA 7 | enantholactam |
| PA 8 | caprylolactam |

AA/BB polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 6T | hexamethylenediamine, terephthalic acid |
| PA 6/6T | (see PA 6 and PA 6T) |
| PA 6/66 | (see PA 6 and PA 66) |
| PA 6/12 | (see PA 6), laurylolactam |
| PA 66/6/610 | (see PA 66, PA 6 and PA 610) |
| PA 6I/6T/PACM | as PA 6I/6T and diaminodicyclohexylmethane |
| PA 6/6I6T | (see PA 6 and PA 6T), hexamethylenediamine, |
| | isophthalic acid |

It is clear for a skilled person that component (A) and component (B) are not identical. In other words, component (B) is not selected from a polyamide MXD6.

Preferably, component (B) is selected from the group consisting of polyamide 6 (PA 6), polyamide 66 (PA 6,6) and polyamide 66/6 (PA 6/6,6).

The present invention therefore also provides a sinter powder (SP) in which the at least one semicrystalline polyamide according to component (B) is selected from the group consisting of polyamide 6 (PA 6), polyamide 66 (PA 6,6) and polyamide 66/6 (PA 6/6,6).

Component (B) generally has a viscosity number of 70 to 350 mL/g, preferably of 70 to 240 mL/g. According to the invention, the viscosity number is determined from a 0.5% by weight solution of component (B) and in 96% by weight sulfuric acid at 25° C. to ISO 307.

Component (B) preferably has a weight-average molecular weight (M_{W}) in the range from 500 to 2 000 000 g/mol, more preferably in the range from 5 000 to 500 000 g/mol and especially preferably in the range from 10 000 to 100 000 g/mol. The weight-average molecular weight (Mw) is determined according to ASTM D4001.

Component (B) typically has a melting temperature (T_{M(B)}). The melting temperature (T_{M(B)}) of component (B) is, for example, in the range from 150 to 300° C. and preferably in the range from 180 to 270° C. The melting temperature (T_{M(B)}) of component (B) is determined by means of differential scanning calorimetry as described above for the melting temperature (T_{M}) of the sinter powder (SP).

Component (B) also typically has a glass transition temperature (T_{G(B)}). The glass transition temperature (T_{G(B)}) of component (B) is, for example, in the range from 0 to 110° C. and preferably in the range from 40 to 105° C.

The glass transition temperature (T_{G(B)}) of component (B) is determined by means of differential scanning calorimetry. For determination, in accordance with the invention, first a first heating run (H1), then a cooling run (C) and subsequently a second heating run (H2) is measured on a sample of component (B) (starting weight about 8.5 g). The heating rate in the first heating run (H1) and in the second heating run (H2) is 20 K/min; the cooling rate in the cooling run (C) is likewise 20 K/min. In the region of the glass transition of component (B), a step is obtained in the second heating run (H2) in the DSC diagram. The glass transition temperature (T_{G(B)}) of component (B) corresponds to the temperature at half the step height in the DSC diagram.

### Component (C)

Component (C) is at least one additive.

In the context of the present invention, “at least one additive” means either exactly one additive or a mixture of two or more additives.

Additives as such are known to those skilled in the art. For example, the at least one additive is selected from the group consisting of antinucleating agents, stabilizers, conductive additives, end group functionalizers, dyes, antioxidants (preferably sterically hindered phenols, and phosphites as secondary stabilizers) and colour pigments.

The present invention therefore also provides a sinter powder (SP) in which component (C) is selected from the group consisting of antinucleating agents, stabilizers, conductive additives, end group functionalizers, dyes, antioxidants and colour pigments.

An example of a suitable antinucleating agent is lithium chloride.

Suitable stabilizers are, for example, phenols, phosphites and copper stabilizers.

Suitable conductive additives are carbon fibres, metals, stainless steel fibres, carbon nanotubes and carbon black.

Suitable end group functionalizers are, for example, terephthalic acid, adipic acid and propionic acid.

Suitable dyes and colour pigments are, for example, carbon black and iron chromium oxides.

Suitable antioxidants are, for example, Irganox® 245, Irganox® 1076, Irganox® B900, Irganox® 1098 and Irgafos® 168 from BASF SE or Weston® TNPP phosphite from Addivant.

If the sinter powder comprises component (C), it comprises at least 0.1% by weight of component (C), preferably at least 0.2% by weight of component (C), based on the sum total of the proportions by weight of components (A), (B), (C) and (D), preferably based on the total weight of the sinter powder (SP).

### Component (D)

According to the invention, component (D) is at least one reinforcer.

In the context of the present invention, “at least one reinforcer” means either exactly one reinforcer or a mixture of two or more reinforcers.

In the context of the present invention, a reinforcer is understood to mean a material that improves the mechanical properties of shaped bodies produced by the process of the invention compared to shaped bodies that do not comprise the reinforcer.

Reinforcers as such are known to those skilled in the art. Component (D) may, for example, be in spherical form, in platelet form or in fibrous form.

Preferably, the at least one reinforcer is in platelet form or in fibrous form.

A “fibrous reinforcer” is understood to mean a reinforcer in which the ratio of length of the fibrous reinforcer to the diameter of the fibrous reinforcer is in the range from 2:1 to 40:1, preferably in the range from 3:1 to 30:1 and especially preferably in the range from 5:1 to 20:1, where the length of the fibrous reinforcer and the diameter of the fibrous reinforcer are determined by microscopy by means of image evaluation on samples after ashing, with evaluation of at least 70 000 parts of the fibrous reinforcer after ashing.

The length of the fibrous reinforcer in that case is typically in the range from 5 to 1 000 μm, preferably in the range from 10 to 600 μm and especially preferably in the range from 20 to 500 μm, determined by means of microscopy with image evaluation after ashing.

The diameter in that case is, for example, in the range from 1 to 30 μm, preferably in the range from 2 to 20 μm and especially preferably in the range from 5 to 15 μm, determined by means of microscopy with image evaluation after ashing.

In a further preferred embodiment, the at least one reinforcer is in platelet form. In the context of the present invention, “in platelet form” is understood to mean that the particles of the at least one reinforcer have a ratio of diameter to thickness in the range from 4:1 to 10:1, determined by means of microscopy with image evaluation after ashing.

Suitable reinforcers are known to those skilled in the art and are selected, for example, from the group consisting of carbon nanotubes, carbon fibres, boron fibres, glass fibres, glass beads, silica fibres, ceramic fibres, basalt fibres, aluminosilicates, magnesium silicates, calcium carbonates, cellulose, lignin, aramid fibres and polyester fibres.

The present invention therefore also provides a sinter powder (SP) in which component (D) is selected from the group consisting of carbon nanotubes, carbon fibres, boron fibres, glass fibres, glass beads, silica fibres, ceramic fibres, basalt fibres, aluminosilicates, magnesium silicates, calcium carbonates, cellulose, lignin, aramid fibres and polyester fibres.

The at least one reinforcer is preferably selected from the group consisting of aluminosilicates, glass fibres, glass beads, silica fibres and carbon fibres.

The at least one reinforcer is more preferably selected from the group consisting of aluminosilicates, glass fibres, glass beads and carbon fibres. These reinforcers may additionally have been amino-functionalized.

Suitable silica fibres are, for example, wollastonite. A suitable magnesium silicate is, for example, talc.

Suitable aluminosilicates are known as such to the person skilled in the art. Aluminosilicates refer to compounds comprising Al₂O₃ and SiO₂. In structural terms, a common factor among the aluminosilicates is that the silicon atoms are tetrahedrally coordinated by oxygen atoms and the aluminum atoms are octahedrally coordinated by oxygen atoms. Aluminosilicates may additionally comprise further elements.

Preferred aluminosilicates are sheet silicates. Particularly preferred aluminosilicates are calcined aluminosilicates, especially preferably calcined sheet silicates. The aluminosilicate may additionally have been amino-functionalized.

If the at least one reinforcer is an aluminosilicate, the aluminosilicate may be used in any form. For example, it can be used in the form of the pure aluminosilicate, but it is likewise possible that the aluminosilicate is used in mineral form. Preferably, the aluminosilicate is used in mineral form. Suitable aluminosilicates are, for example, feldspars, zeolites, sodalite, sillimanite, andalusite and kaolin. Kaolin is a preferred aluminosilicate.

Kaolin is one of the clay rocks and comprises essentially the mineral kaolinite. The empirical formula of kaolinite is Al₂[(OH)₄/Si₂O₅]. Kaolinite is a sheet silicate. As well as kaolinite, kaolin typically also comprises further compounds, for example titanium dioxide, sodium oxides and iron oxides. Kaolin preferred in accordance with the invention comprises at least 98% by weight of kaolinite, based on the total weight of the kaolin.

If the sinter powder comprises component (D), it comprises preferably at least 10% by weight of component (D), based on the sum total of the percentages by weight of components (A), (B), (C) and (D), preferably based on the total weight of the sinter powder (SP).

### Shaped Bodies

The present invention also provides a method of producing a shaped body, comprising the steps of:
i) providing a layer of the sinter powder (SP),
ii) exposing the layer of the sinter powder (SP) provided in step i) in order to form the shaped body.

### Step i)

In step i), a layer of the sinter powder (SP) is provided.

The layer of the sinter powder (SP) can be provided by any methods known to those skilled in the art. Typically, the layer of the sinter powder (SP) is provided in a construction space on a construction platform. The temperature of the construction space may optionally be controlled.

The construction space has, for example, a temperature in the range from 1 to 100 K (Kelvin) below the melting temperature (T_{M(SP)}) of the sinter powder (SP), preferably a temperature in the range from 5 to 50 K below the melting temperature (T_{M(SP)}) of the sinter powder (SP), and especially preferably a temperature in the range from 10 to 25 K below the melting temperature (T_{M(SP)}) of the sinter powder (SP).

The construction space has, for example, a temperature in the range from 90 to 270° C., preferably in the range from 140 to 265° C., and especially preferably in the range from 165 to 245° C.

The layer of the sinter powder (SP) can be provided by any methods known to those skilled in the art. For example, the layer of the sinter powder (SP) is provided by means of a coating bar or a roll in the thickness to be achieved in the construction space.

The thickness of the layer of the sinter powder (SP) which is provided in step i) may be as desired. For example, it is in the range from 50 to 300 μm, preferably in the range from 60 to 200 μm and especially preferably in the range from 70 to 150 μm.

### Step ii)

In step ii), the layer of the sinter powder (SP) provided in step i) is exposed.

On exposure, at least some of the layer of the sinter powder (SP) melts. The molten sinter powder (SP) coalesces and forms a homogeneous melt. After the exposure, the molten part of the layer of the sinter powder (SP) cools down again and the homogeneous melt solidifies again.

Suitable methods of exposure include all methods known to those skilled in the art. Preferably, the exposure in step ii) is effected with a radiation source. The radiation source is preferably selected from the group consisting of infrared sources and lasers. Especially preferred infrared sources are near infrared sources.

The present invention therefore also provides a method in which the exposing in step ii) is effected with a radiation source selected from the group consisting of lasers and infrared sources.

Suitable lasers are known to those skilled in the art and are, for example, fiber lasers, Nd:YAG lasers (neodymium-doped yttrium aluminum garnet laser) or carbon dioxide lasers. The carbon dioxide laser typically has a wavelength of 10.6 μm.

If the radiation source used in the exposing in step ii) is a laser, the layer of the sinter powder (SP) provided in step i) is typically exposed locally and briefly to the laser beam. This selectively melts just the parts of the sinter powder (SP) that have been exposed to the laser beam. If a laser is used in step ii), the method of the invention is also referred to as selective laser sintering. Selective laser sintering is known per se to those skilled in the art.

If the radiation source used in the exposing in step ii) is an infrared source, especially a near infrared source, the wavelength at which the radiation source radiates is typically in the range from 780 nm to 1 000 μm, preferably in the range from 780 nm to 50 μm and especially in the range from 780 nm to 2.5 μm.

In the exposing in step ii), in that case, the entire layer of the sinter powder (SP) is typically exposed. In order that only the desired regions of the sinter powder (SP) melt in the exposing, an infrared-absorbing ink (IR-absorbing ink) is typically applied to the regions that are to melt.

The method of producing the shaped body in that case preferably comprises, between step i) and step ii), a step i-1) of applying at least one IR-absorbing ink to at least part of the layer of the sinter powder (SP) provided in step i).

The present invention therefore also further provides a method of producing a shaped body, comprising the steps of
i) providing a layer of a sinter powder (SP),
i-1) applying at least one IR-absorbing ink to at least part of the layer of the sinter powder (SP) provided in step i),
ii) exposing the layer of the sinter powder (SP) provided in step i) to which the IR-absorbing ink has been applied.

Suitable IR-absorbing inks are all IR-absorbing inks known to those skilled in the art, especially IR-absorbing inks known to those skilled in the art for high-speed sintering.

IR-absorbing inks typically comprise at least one absorber that absorbs IR radiation, preferably NIR radiation (near infrared radiation). In the exposing of the layer of the sinter powder (SP) in step ii), the absorption of the IR radiation, preferably the NIR radiation, by the IR absorber present in the IR-absorbing inks results in selective heating of the part of the layer of the sinter powder (SP) to which the IR-absorbing ink has been applied.

The IR-absorbing ink may, as well as the at least one absorber, comprise a carrier liquid. Suitable carrier liquids are known to those skilled in the art and are, for example, oils or solvents.

The at least one absorber may be dissolved or dispersed in the carrier liquid.

If the exposing in step ii) is effected with a radiation source selected from infrared sources and if step i-1) is conducted, the method of the invention is also referred to as high-speed sintering (HSS) or multijet fusion (MJF) method. These methods are known per se to those skilled in the art.

After step ii), the layer of the sinter powder (SP) is typically lowered by the layer thickness of the layer of the sinter powder (SP) provided in step i) and a further layer of the sinter powder (SP) is applied. This is subsequently exposed again in step ii).

This firstly bonds the upper layer of the sinter powder (SP) to the lower layer of the sinter powder (SP); in addition, the particles of the sinter powder (SP) within the upper layer are bonded to one another by fusion.

In the process of the invention, steps i) and ii) and optionally i-1) can thus be repeated.

By repeating the lowering of the powder bed, the applying of the sinter powder (SP) and the exposure and hence the melting of the sinter powder (SP), three-dimensional shaped bodies are produced. It is possible to produce shaped bodies that also have cavities, for example. No additional support material is necessary since the unmolten sinter powder (SP) itself acts as a support material.

The present invention also further provides for the use of the sinter powder (SP) in a sintering method, preferably in a selective laser sintering method (SLS), a high-speed sintering method (HSS) or a multi-jet fusion method (MJF).

The present invention therefore also further provides a shaped body obtained by the methods of the invention.

The process of the invention affords a shaped body. The shaped body can be removed from the powder bed directly after the solidification of the sinter powder (SP) molten on exposure in step ii). It is likewise possible first to cool the shaped body and only then to remove it from the powder bed. Any adhering particles of the sinter powder (SP) that have not been melted can be mechanically removed from the surface by known methods. Methods for surface treatment of the shaped body include, for example, vibratory grinding or barrel polishing, and also sandblasting, glass bead blasting or microbead blasting.

It is also possible to subject the shaped bodies obtained to further processing or, for example, to treat the surface.

If step i-1) has been conducted, the shaped body additionally typically comprises the IR-absorbing ink.

It will be clear to those skilled in the art that, as a result of the exposure of the sinter powder (SP), components (A) and (B), and optionally (C) and/or (D), can enter into chemical reactions and be altered as a result. Such reactions are known to those skilled in the art.

Preferably, components (A) and (B), and optionally (C) and (D), do not enter into any chemical reaction on exposure in step ii); instead, the sinter powder (SP) merely melts.

The present invention also provides the use of at least one semicrystalline polyamide (B) comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6 in a sinter powder (SP) comprising at least one polyamide MXD6 (A) for improving the mechanical properties of shaped bodies made from said sinter powder (SP).

The invention is elucidated in detail hereinafter by examples, without restricting it thereto.

### EXAMPLES

The following components are used:

Polyamide MXD6 (component (A)):

| | |
|---|---|
| (A1) polyamide MXD6 | (S6007, Mitsubishi Chemical) |

Semicrystalline polyamide (component (B)):

| | |
|---|---|
| (B1) polyamide 6 | (Ultramid ® B27E, BASF SE) |

Amorphous polyamide:

| | |
|---|---|
| (AM1) polyamide 6I/6T | (Grivory G16, EMS) |

Additive (component (C)):

| | |
|---|---|
| (C1) Irganox 1098 | (N,N′-hexane-1,6-diylbis(3-(3,5-di-tert-butyl-4- |
| | hydroxyphenylpropionamide)), BASF SE) |
| (C2) Irgafos 126 | (3,9-Bis(2,4-di-tert-butylphenoxy)-2,4,8,10- |
| | tetraoxa-3,9-diphosphaspiro[5.5]undecane, |
| | BASF SE) |

Table 1 reports essential parameters of the polyamides used.

TABLE 1

| | | AEG | CEG | | | Zero viscosity |
|---|---|---|---|---|---|---|
| | | [mmol/ | [mmol/ | T_{M} | T_{G} | η₀ |
| | Polyamide | kg] | kg] | [° C.] | [° C.] | [Pas] |
| A1 | PA MXD6 | 16 | 72 | 234 | 86 | 945 (at 255° C.) |
| B1 | PA 6 | 36 | 54 | 219 | 53 | 400 (at 240° C.) |
| AM1 | PA 6I/6T | 37 | 86 | — | 125 | 770 (at 240° C.) |

AEG indicates the amino end group concentration. This is determined by means of titration. For determination of the amino end group concentration (AEG), 1 g of the respective component was dissolved in 30 mL of a phenol/methanol mixture (volume ratio of phenol:methanol 75:25) and then subjected to potentiometric titration with 0.2 N hydrochloric acid in water.

The CEG indicates the carboxyl end group concentration. This is determined by means of titration. For determination of the carboxylic end group concentration (CEG), 1 g of the respective component was dissolved in 30 mL of benzyl alcohol. This was followed by visual titration at 120° C. with 0.05 N potassium hydroxide solution in water.

The melting temperature (T_{M}) of the semicrystalline polyamides and the glass transition temperatures (T_{G}) of the semicrystalline polyamides and the amorphous polyamides were each determined by means of differential scanning calorimetry. For determination of the melting temperature (T_{M}), as described above, a first heating run (H1) at a heating rate of 20 K/min was measured. The melting temperature (T_{M}) then corresponded to the temperature at the maximum of the melting peak of the heating run (H1).

For determination of the glass transition temperature (T_{G}), after the first heating run (H1), a cooling run (C) and subsequently a second heating run (H2) were measured. The cooling run was measured at a cooling rate of 20 K/min; the first heating run (H1) and the second heating run (H2) were measured at a heating rate of 20 K/min. The glass transition temperature (T_{G}) was then determined as described above at half the step height of the second heating run (H2).

The zero shear rate viscosity no was determined with a “DHR-1” rotary viscometer from TA Instruments and a plate-plate geometry with a diameter of 25 mm and a plate separation of 1 mm. Unequilibrated samples were dried at 80° C. under reduced pressure for 7 days and these were then analyzed with a time-dependent frequency sweep (sequence test) with an angular frequency range of 500 to 0.5 rad/s. The following further analysis parameters were used: deformation: 1.0%, analysis temperature: 240° C. for components (B1) and (AM1) and 255° C. for component (A1), analysis time: 20 min, preheating time after sample preparation: 1.5 min.

### Sintering Powder (SP) for Selective Laser Sintering

For production of the sinter powder (SP) according to inventive example IE3 and comparative example CE2, the components specified in table 1 were compounded in a twin-screw extruder (25 mm) with subsequent strand pelletization in the ratio specified in table 2 and at the parameters specified in table 3.

TABLE 2

| | (A1) | (B1) | (AM1) | (C1) | (C2) |
|---|---|---|---|---|---|
| Example | [% by wt.] | [% by wt.] | [% by wt.] | [% by wt.] | [% by wt.] |
| CE1 | 100 | — | — | — | — |
| CE2 | 79.35 | — | 20 | 0.4 | 0.25 |
| IE3 | 79.35 | 20 | | 0.4 | 0.25 |

TABLE 3

| | Speed | Throughput | Temperature |
|---|---|---|---|
| Example | [rpm*] | [kg/h] | [° C.] |
| CE1 | — | — | — |
| CE2 | 300 | 10 | 275 |
| IE3 | 250 | 19 | 280 |

*rpm = revolutions per minute

The pelletized material thus obtained was ground at a counter rotating pin mill to a particle size of 10 to 100 μm. After the grinding, the obtained powder was mixed with 0.2% by weight, based on components (A1) and optionally components (B1), (AM1), (C1) and (C2), of a free flow aid (Al₂O₃; Aeroxide® Alu C, from Evonik).

PA MXD6 according to comparative example CE1 was initially present in granulate form. The granulate was also ground at a counter rotating pin mill to a particle size of 10 to 100 μm. After the grinding, the obtained powder was also mixed with 0.2% by weight, based on component (A1), of a free flow aid (Al₂O₃; Aeroxide® Alu C, from Evonik).

The properties of the sinter powder (SP) obtained were determined as described above. In addition, the bulk density according to DIN EN ISO 60 and the tamped density according to DIN EN ISO 787-11 were determined, as was the Hausner factor as the ratio of tamped density to bulk density.

The particle size distribution, reported as the D10, D50 and D90, was determined as described above with a Malvern Mastersizer.

The crystallization temperature (T_{C}) was determined by means of differential scanning calorimetry. For this purpose, first a heating run (H) at a heating rate of 20 K/min and then a cooling run (C) at a cooling rate of 20 K/min were measured. The crystallization temperature (T_{C}) is the temperature at the extreme of the crystallization peak.

The magnitude of the complex shear viscosity was determined by means of a plate-plate rotary rheometer at an angular frequency of 0.5 rad/s and a temperature of 255° C. A “DHR-1” rotary viscometer from TA Instruments was used, with a diameter of 25 mm and a plate separation of 1 mm. Unequilibrated samples were dried at 80° C. under reduced pressure for 7 days and these were then analyzed with a time-dependent frequency sweep (sequence test) with an angular frequency range of 500 to 0.5 rad/s. The following further analysis parameters were used: deformation: 1.0%, analysis time: 20 min, preheating time after sample preparation: 1.5 min.

The results can be seen in table 4.

TABLE 4

| | Magnitude | | | | | | | | | | |
|---|---|---|---|---|---|---|---|---|---|---|---|
| | of complex | | | | | | | | | | |
| | shear | | | | Width | | | | | | |
| | viscosity | | | | crystallisation | | | | | | |
| | at 0.5 | | | | peak at | | | | | | |
| | rad/s, | | | | half | Bulk | Tamped | | | | |
| | 255° C. | T_{M} | T_{C} | T_{G} | height | Density | density | Hausner | D10 | D50 | D90 |
| Example | [Pas] | [° C.] | [° C.] | [° C.] | [K] | [kg/m³] | [kg/m³] | factor | [μm] | [μm] | [μm] |
| CE1 | 945 | 235 | 184 | 87 | 14 | 468 | 605 | 1.29 | 24 | 50 | 92 |
| CE2 | 1 600 | 231 | 152 | 88 | 38 | 426 | 548 | 1.29 | 39 | 65 | 105 |
| IE3 | 1 690 | 234 | 173 | 79 | 6 | 466 | 545 | 1.17 | 39 | 65 | 108 |

It is clearly apparent that the sinter powder (SP) of the invention (inventive example IE3) shows a significant increase of the crystallisation rate (increased crystallization temperature T_{C}) compared to the sinter powder of the state of the art, comprising an amorphous polyamide (comparative examples CE2).

Furthermore, the crystallization behaviour of the inventive sinter powder (SP) (inventive examples IE3) is clearly more consistent compared to the pure polyamide MXD6 powder (comparative example CE1) which can be seen in a narrowing of the crystallisation peak, the width of which decreases at half height from 14 K to 9 K. Thus, the polyamide 6 causes a quasi-nucleation of polyamide MXD6. However, surprisingly, the crystallisation temperature of the inventive sinter powder (SP) is increased significantly less because of grinding (173° C.) than in the pure polyamide MXD6 powder (184° C.).

### Laser Sintering Experiments

The sinter powder (SP) was introduced with a layer thickness of 0.1 mm into the cavity at the temperature specified in table 5. The sinter powder (SP) was subsequently exposed to a laser with the laser power output specified in table 5 and the point spacing specified, with a speed of the laser over the sample during exposure of 15 m/s. The point spacing is also known as laser spacing or lane spacing. Selective laser sintering typically involves scanning in stripes. The point spacing gives the distance between the centres of the stripes, i.e. between the two centres of the laser beam for two stripes. Experiments CE2-2 and IE3-2 were performed applying double laser scanning with laser power output 45 W. All the other experiments used single laser scanning.

TABLE 5

| | Sinter | | Laser power | Laser | Point |
|---|---|---|---|---|---|
| | powder | Temperature | output | speed | spacing |
| Experiment | used | [° C.] | [W] | [m/s] | [mm] |
| CE1 | CE1 | 215 | 45 | 15 | 0.15 |
| CE2-1 | CE2 | 200 | 45 | 15 | 0.15 |
| CE2-2 | CE2 | 200 | 45/45 | 15 | 0.15 |
| IE3-1 | IE3 | 217 | 45 | 15 | 0.12 |
| IE3-2 | IE3 | 200 | 45/45 | 15 | 0.15 |

Subsequently, the properties of the tensile bars (sinter bars) obtained were determined. The resultant tensile bars (sinter bars) were tested in the dry state after drying at 80° C. for 336 h under reduced pressure. In addition, Charpy specimens were produced, which were likewise tested under dry conditions (according to ISO179-2/1eU: 1997+Amd.1:2011).

The tensile strength, tensile modulus of elasticity and elongation at break was determined according to ISO 527-1:2012.

The processability of the sinter powder and the warpage of the sinter bars was assessed qualitatively using the scale given in table 6.

TABLE 6

| | Warpage of fractional | Sintering | Application |
|---|---|---|---|
| Grade | bar from SLS | behaviour | behaviour |
| 1 | Very low, flat | Very good | Very good |
| | components | | |
| 2 | Low | Good | Good |
| 3 | Moderate | Moderate | Moderate |
| 4 | Marked | Adequate | Adequate |
| 5 | Severe | Inadequate | Inadequate |

Heat deflection temperature (HDT) was determined according to ISO 75-2:2013. using Method A with an edge fiber stress of 1.8 N/mm².

The results are shown in table 7.

TABLE 7

| | Charpy | Charpy | | | | | | Warpage | | |
|---|---|---|---|---|---|---|---|---|---|---|
| | impact | impact | | Tensile | | | | of flexural | | |
| | resistance, | resistance, | Tensile | modulus of | Elongation | Elongation | | bar | Sintering | Application |
| | unnotched | notched | strength | elasticity | at break | at yield | HDT A | from SLS | behaviour | behaviour |
| Experiment | [kJ/m²] | [kJ/m²] | [MPa] | [MPa] | [%] | [%] | [° C.] | [grade] | [grade] | [grade] |
| CE1 | 5.7 | 1.8 | 67 | 4380 | 1.7 | 1.7 | — | 4 | 4 | 5 |
| CE2-1 | — | — | 34 | 2700 | 1.4 | 1.4 | — | 5 | 3 | 4 |
| CE2-2 | 6.3 | 2.6 | 65 | 3800 | 2.0 | 1.9 | 102 | 5 | 1 to 2 | 4 |
| IE3-1 | 10 | 1.7 | 85 | 3950 | 3.0 | 3.0 | 100 | 2 | 1 | 1 |
| IE3-2 | — | — | 92 | 3900 | 3.7 | — | 97 | 2 | 2 | 1 |

As can be seen from table 7, the sinter powders (SP) of the invention ((IE3-1) and (IE3-2)) show very good application and sintering behaviour and low warpage of the flexural bars obtained from compared to the sinter powders of the state of the art.

In addition, significant advantages are apparent in the mechanical properties. The shaped bodies, produced from the inventive sinter powders (SP) (inventive examples IE3-1 and IE3-2), show a higher elongation at break of at least 3% in both single and double laser scan, as well as a higher elongation at yield, a higher tensile strength and a higher tensile modulus of elasticity, compared to the shaped bodies produced from sinter powders of the state of the art (comparative examples CE2-1 and CE2-2). Further, the shaped bodies, produced from the inventive sinter powders (SP) (inventive examples IE3-1 and IE3-2), show a higher elongation at break compared to the shaped body produced from the sinter powder comprising pure polyamide MXD6 (CE1). The shaped bodies produced from sinter powders of the state of the art (comparative examples CE1, CE2-1 and CE2-2), therefore, show brittle break behaviour in both single and double laser scan with only low elongation at break of at most 2%.

Table 8 shows the properties of the shaped bodies in the conditioned state. For conditioning, the shaped bodies were stored after the above-described drying at 70° C. and 62% relative humidity for 336 hours.

TABLE 8

| | Elongation at break | Elongation at yield |
|---|---|---|
| Example | [%] | [%] |
| CE1 | 2.1 | 2.1 |
| CE2-1 | 2.3 | 2.3 |
| CE2-2 | 2.8 | 2.8 |
| IE3-1 | 11 | 6.5 |
| IE3-2 | 10 | 6.4 |

Also after conditioning, the elongation at break and the elongation at yield values of the shaped bodies, produced from the inventive sinter powders (SP) (inventive examples IE3-1 and IE3-2), are higher than the elongation at break and the elongation at yield values of the shaped bodies, produced from a sinter powder of the state of the art (comparative examples CE1, CE2-1 and CE2-2).

1.-15. (canceled)

16. A sinter powder (SP) comprising the following components:
(A) at least one polyamide MXD6,
(B) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
(C) optionally at least one additive and
(D) optionally at least one reinforcer,
wherein the sinter powder (SP) comprises in the range from 50% to 95% by weight of component (A), in the range from 5% to 50% by weight of component (B), in the range from 0% to 20% by weight of component (C), and in the range from 0% to 40% by weight of component (D), based in each case on the total weight of the sinter powder (SP) and wherein the at least one semicrystalline polyamide according to component (B) is selected from the group consisting of polyamide 6 (PA 6), polyamide 66 (PA 6,6) and polyamide 66/6 (PA 6/6,6).

17. The sinter powder (SP) according to claim 16, wherein component (C) is selected from the group consisting of antinucleating agents, stabilizers, conductive additives, end group functionalizers, dyes, antioxidants and colour pigments.

18. The sinter powder (SP) according to claim 16, wherein component (D) is selected from the group consisting of carbon nanotubes, carbon fibres, boron fibres, glass fibres, glass beads, silica fibres, ceramic fibres, basalt fibres, aluminosilicates, magnesium silicates, calcium carbonates, cellulose, lignin, aramid fibres and polyester fibres.

19. The sinter powder (SP) according to claim 16, wherein the sinter powder (SP) has a median particle size (D50) in the range from 40 to 80 μm.

20. The sinter powder (SP) according to claim 16, wherein the sinter powder (SP) has
a D10 in the range from 10 to 60 μm,
a D50 in the range from 40 to 80 μm and
a D90 in the range from 50 to 150 μm.

21. The sinter powder (SP) according to claim 16, wherein the sinter powder (SP) has a melting temperature (T_{M(SP)}) in the range from 190 to 250° C.

22. The sinter powder (SP) according to claim 16, wherein the sinter powder (SP) has a crystallization temperature (T_{C(SP)}) in the range from 140 to 200° C.

23. A method of producing a shaped body, comprising the steps of:
i) providing a layer of the sinter powder (SP) according to claim 16,
ii) exposing the layer of the sinter powder (SP) provided in step i) in order to form the shaped body.

24. A shaped body obtained by the method according to claim 23.

25. The use of the sinter powder (SP) according to claim 16 in a sintering method, preferably in a selective laser sintering method (SLS), a high-speed sintering method (HSS) or a multi-jet fusion method (MJF).

26. A method of producing the sinter powder (SP) according to claim 16, comprising the steps of
a) mixing components (A) and (B), and optionally (C) and/or (D):
(A) at least one polyamide MXD6,
(B) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
(C) optionally at least one additive, and/or
(D) optionally at least one reinforcer,
in an extruder to obtain an extrudate (E) comprising components (A) and (B), and optionally (C) and/or (D),
b) pelletizing the extrudate (E) obtained in step a) to obtain a granulate (G) comprising components (A) and (B), and optionally (C) and/or (D),
c) micronizing the granulate (G) obtained in step b) to obtain the sinter powder (SP).

27. A sinter powder (SP) obtained by the method according to claim 26.

28. The use of at least one semicrystalline polyamide (B) comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6 in a sinter powder (SP) comprising at least one polyamide MXD6 (A) for improving the mechanical properties of shaped bodies made from said sinter powder (SP),
wherein the sinter powder (SP) comprises in the range from 50% to 95% by weight of component (A), in the range from 5% to 50% by weight of component (B), in the range from 0% to 20% by weight of component (C), and in the range from 0% to 40% by weight of component (D), based in each case on the total weight of the sinter powder (SP) and wherein the at least one semicrystalline polyamide according to component (B) is selected from the group consisting of polyamide 6 (PA 6), polyamide 66 (PA 6,6) and polyamide 66/6 (PA 6/6,6).
